(19) United States
(12) Patent Application Publication
(10) Pub. No.: US 2013/0013190 A1
(43) Pub. Date: Jan. 10, 2013

(54) Navigation Method for Mobile Terminals with Centralized Server

(75) Inventors: Pierre Hayot, Clamart (FR); Pierre Dufay, Versailles (FR)

(73) Assignee: Societe de Technologie Michelin, Clermont-Ferrand (FR)

(21) Appl. No.: 12/521,868

(22) PCT Filed: Dec. 21, 2007
(86) PCT No.: PCT/EP2007/011408

§ 371 Date: Apr. 27, 2010

(30) Foreign Application Priority Data
Dec. 31, 2006 (FR) 0611547

(51) Int. Cl. G01C 21/34

(52) U.S. Cl. 701/422

(57) ABSTRACT

A navigation method allowing a centralized server to supply guidance functions, in which a plurality of mobile terminals is provided with a central server and in which, following the receipt of a request from a terminal, the central server determines at least one itinerary between a given departure point and a given arrival point, defines a guidance zone making it possible to progress from this departure point to the arrival point, determines a plurality of guide points and, for each of these points, a guidance instruction, these guide points and the associated instructions being capable of allowing the user to move in the zone by receiving guidance instructions for the purpose of allowing the terminal to come gradually closer to the arrival point, the server transmits these guide points to the requesting terminal and the terminal receives the guide points.

The invention relates to a navigation method, particularly suitable for use with a central device capable of being connected at least occasionally to a plurality of mobile stations.

Two main types of navigation systems are known today. First of all, the oldest and the best known, the standalone devices often designated by the term “onboard”.

The latter comprise a data storage device such as a flash memory, an optical or magnetic disc, or other element, usually containing all of the mapping data of a given zone of use, being able to correspond to a region, a country, a continent, etc. They also comprise an itinerary computer and a guidance system making it possible to generate guidance instructions based on the computed itinerary. This guidance is usually carried out with the aid of a map and/or pictograms and/or sound instructions.

The main advantage of this type of device arises from the fact that the user has all the elements allowing him to operate totally independently, wherever he is, but to the extent that the geographic data are present in memory. In order to use the device in another zone, it is necessary to load the corresponding geographic data. This operation usually causes a period of unavailability, which is more or less long, depending on the loading method used. Furthermore, to carry out the data storage and computing operations, the device must have considerable storage capacities and powerful computing resources. The result of this is a relatively costly device.

The other type relates to delocalised devices, often designated by the term “offboard”. This type of device in fact comprises two key elements: a central server, and a plurality of mobile terminals. The server comprises mapping data such as road charts, points of interest, etc., and an itinerary computer capable of selecting the data which each of the mobile stations needs, according to the predicted itineraries.

Each mobile station has communication means and a network interface adapted to networks such as, for example, a cellular telephone network, a GSM network, wi-fi, wi-max, or other network, making it possible to interchange data with the central server, an itinerary computer using the data sent by the server, and a guidance system making it possible to generate guidance instructions based on the computed itinerary. This guidance is usually carried out with the aid of a map and/or pictograms and/or sound instructions.

Unlike the standalone devices, the mobile terminals or stations do not have all the mapping data. To compensate for this particular feature, they have means allowing them to connect to or enter into communication with the central server, for example in order to retrieve a selection of data that is useful for computing a future itinerary or for completing or correcting a current itinerary. The main advantage of this type of device arises from the fact that the user has indirectly, via the central station, a virtual infinity of data at his disposal. Specifically, it is easy to have, for a central system, considerable data storage means. These data being provided to a plurality of users, the gains achieved may be considerable. On the other hand, in order to be able to make the computations locally with the mobile terminal, the latter must comprise considerable computing capacities, because the itinerary computations are operations that consume considerable resources. Therefore, the current offboard devices comprise both the disadvantages associated with the standalone systems in addition to other disadvantages inherent in their own operating method. Therefore, it has been observed that, historically, the bandwidths allowed relatively limited data streams. Therefore, the known offboard solutions seek to minimize the volume of data interchanged between the server and the stations.

Even by limiting the geographic coverage of the data transmitted by the server to a given mobile terminal, the data travelling over the network are usually voluminous because they comprise many parameters, such as the geometry of the road network, the width of the roadways, the direction of traffic flow, the speed limits, etc. The terminal must process all of these data in order to establish an itinerary and the corresponding guidance. This processing is complex and requires a considerable processor capacity and memory for a mobile terminal.

In addition, the complexity of the data structure makes the changes of communication protocol between the terminal and the server difficult.

Document WO 98/45823 describes an off-board system, in which a central server, following a request submitted by the mobile terminal, determines on the one hand a basic itinerary, and on the other hand, based on roads crossing this itinerary, it determines a neighbourhood zone, making it possible to cover a geographic sector situated in the environment of the basic itinerary. The server finally determines the many itineraries making it possible to reach the destination based on all the roads crossing the basic itinerary and included in the neighbourhood zone. All these itineraries are transmitted in vector form from the server to the terminal which stores all this information. When the basic itinerary is followed, the terminal guides the user by supplying guidance messages. The terminal, which has geo-location means, at all times compares the current position of the vehicle with the basic itinerary. Therefore, if a user departs from the basic itinerary, the terminal detects the point of departure and can identify the fallback itinerary that will be useful. The guidance can continue to the destination point by following one of the fallback itineraries already precalculated. This operating mode therefore involves a transfer of relatively large files between the server and the terminal.

The size of these files requires considerable memory capacity in the terminal. The detection of instances of departure from the basic itinerary is carried out by comparing, in a continuous manner, the current position of the terminal relative to the basic itinerary. This type of test requires a very considerable processor capacity. The terminals used according to this operating mode must therefore be very powerful.

To alleviate this situation, the invention proposes a navigation method allowing a centralized server to supply guidance functions capable of being used by a plurality of mobile terminals, in which a plurality of users is provided with:
a central server comprising memory means capable of containing digital geographic data;
a processor, capable of establishing at least one itinerary between a departure point D and an arrival point A;
means of communication with the plurality of mobile terminals;
a plurality of mobile terminals comprising:
means of communication with the central device;
   and in which, following the receipt of a request, the central server determines at least one itinerary between a given departure point and a given arrival point, defines a guidance zone making it possible to progress at least partially from this departure point to the arrival point, determines, at least for this guidance zone, a plurality of guide points and, for each of these points, a guidance instruction, these guide points and the associated instructions being capable of allowing the user to move in the said zone by receiving guidance instructions for the purpose of allowing the terminal to come gradually closer to the arrival point;
said server transmits these guide points to the mobile terminal;
said terminal receives said guide points;
said terminal, with the aid of the guide points received from the server, guides the terminal by comparing the current position of the terminal with those of the guide points and, in the case of correspondence between this position and a guide point, it supplies a guidance instruction corresponding to the point in question;
said method being characterized in that the guide points are organized according to a tree structure, the root of the tree being the arrival point A of the itinerary and the leaves representing the beginning of a sequence of points guiding to this arrival point, so that, by passing through the tree from a leaf to the root, the user chronologically follows an itinerary leading to the arrival point.

Such a method is particularly valuable more particularly if it is desired to use mobile terminals whose computing and/or memory capacities are relatively limited. Specifically, a limited number of data are stored in the terminal, and the operations to be carried out do not require important processor resources.

Thanks to the use of guide points, the use of vectors is avoided, which requires a considerable capacity in the processor of the terminal, which restricts this technology to the very top-of-the-range terminals. A terminal receives a series of guide points, comprising points passing through the basic itinerary established via the server, and a series of additional or fallback points, not passing through this itinerary. These points actually cover the conditions of departure from the itinerary, and allow the user to continue his route either, depending on the case, by being returned to the basic itinerary, or by continuing a modified itinerary. Thanks to this operating method principle, the method according to the invention allows a less voluminous data transfer, the management of which by the terminal is simpler than a conventional system in which a set of itineraries (basic and fallback) is transferred to the terminal in vector form.

The guidance is carried out not by comparing the current position with a basic itinerary, but rather with a very restricted set of guide points. Such a comparison method requires much less in terms of processor capacity than a comparison with a complete itinerary. A guidance instruction may be supplied in various modes such as visual, sound, or both of these modes at the same time, either by illustrating a driving action to be taken soon (such as for example “in 200 m, turn left, onto rue Marechal”) or by illustrating this manoeuvre with the aid of a schematic instruction or a pictogram.

Advantageously, one of the leaves corresponds to the departure position of the itinerary, the other leaves being points through which the user passes if he departs from the optimal itinerary.

According to an advantageous embodiment, the management system of the station stores the last guide point through which it has passed and, if it passes close to a new point:
either this point is downstream of the last guide point in the direction of travel through the tree and then it initiates the voice instruction and the cycle recommences;
or it is another leaf of the tree and then it initiates the corresponding voice instruction and resumes the tree journey from this other leaf;
or it is neither of these two cases: the management system then runs a test in order to reveal a possible particular case and, in the absence of a particular case, the point is ignored because it corresponds to another itinerary crossing or running alongside that followed by the user.

A particular case is capable of being revealed if the mobile terminal is incapable of determining its position, or else if several consecutive detections of points of another branch are observed. It is then deduced that the mobile terminal is actually on the other branch in question.

The guidance data are preferably represented by a set of points close to which the mobile station must initiate an action. The latter may be a guidance message to the user or a connection to the server to obtain additional guidance data.

According to an advantageous embodiment, when the terminal detects a position corresponding substantially to a renewal point, it launches a request for renewal of the guidance zone to the server, which, depending on the position of this point, establishes a new guidance zone making it possible to link the latter point to the destination point of the itinerary.

According to another advantageous embodiment, a possible division of the guidance zone into partial or intermediate zones is carried out by the server according to the memory capacity of the terminal if the latter is insufficient to effectively manage all the data to be transmitted by the server.

According to another advantageous embodiment, the server detects the type of terminal and consults a database allowing it to obtain the corresponding technical characteristics such as, for example, the memory capacity.

The server then has the data it needs to adjust the size of the guidance zone so that it can be used by the terminal to prevent the terminal being congested.

The guidance zone is preferably defined according to the memory capacity and/or the processor capacity of the requesting terminal; if these parameters do not make it possible to take account of the whole zone, the latter is divided into a plurality of partial guidance zones which will be transmitted successively to the terminal.

According to an advantageous variant, the data of a new partial guidance zone are transmitted to a terminal when the latter passes close to a zone renewal point.

The established itinerary may be optimized according to given criteria such as: the fastest, the shortest, passing by a given location or address, avoiding highways, etc. These criteria may if necessary be modified by the user.

The requests and/or the departure point D and arrival point A may be supplied by the user via the requesting terminal, by the server, by an external device, by a third party, etc.

The mobile terminals used advantageously have means for presenting an itinerary, such as a screen and/or sound reproduction means.

In the field of mobile or cellular telephony, it is noted that the capacity of the wireless networks is changing faster than the power of the terminals. The available bandwidth is increasing thanks to the spread of new generation networks such as the GPRS and UMTS networks. In parallel, the cost of calls is reducing rapidly. Thanks to the method according to the invention, maximum benefit is made of the provision of considerable data transfer resources, by transferring from the server to the stations a more considerable data density than in the previous systems, while minimizing the use of the microprocessor resources of the terminals. It is then possible to spread the use of this method with a very vast range of terminals, such as for example simple portable or cellular telephones, even though these terminals have very restricted internal computing resources.

This method simplifies the interchanges between the terminals and the server and limits the tasks incumbent upon the terminals. It can therefore operate on much less powerful apparatus, such as entry-level mobile telephones. The terminals can operate even if, before the first file transmission, no geographic datum is present on a terminal.

According to an advantageous embodiment, the information transmitted by the server to a given terminal comprises data relating only to a portion of the overall itinerary established. According to the progress of the station along the itinerary, the central server transmits other portions of the overall itinerary. These successive transmittals make it possible, bit by bit, to reconstitute the whole overall itinerary. These multiple transmittals make it possible to limit the size of the files transmitted and the requirements in terms of memory capacity of the terminals. Moreover, in the event of a departure from the basic itinerary without returning to it, the transfer and storing of long itinerary files which are mostly not used are avoided.

The invention also proposes a software program comprising programmed code elements for the use of the method explained above, when the said software is loaded into a computer system and executed by said computer system. Said software is preferably in the form of a product stored on a medium that can be read by a computer system, comprising programmed code elements.

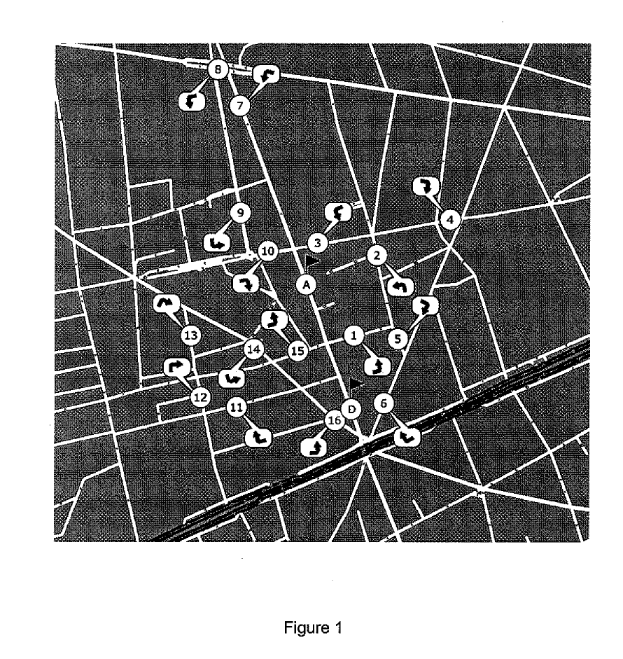

The invention will now be described with reference to FIGS. 1 to 9, which are appended as a non-limiting example, and in which the figures represent:

FIG. 1: an example of positioning of the guidance instructions for an itinerary from D to A;

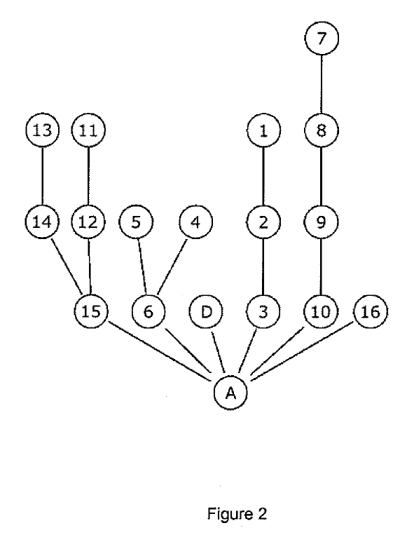

FIG. 2: an example of an instruction tree corresponding to the case of FIG. 1;

FIG. 3: an example of guidance along the optimal itinerary;

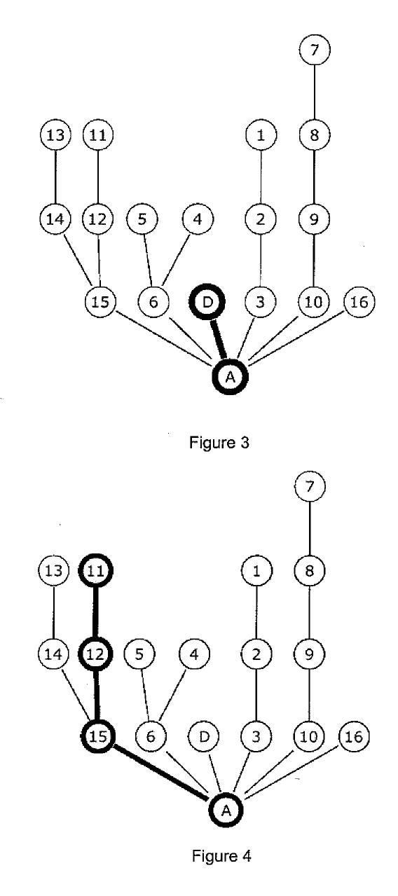

FIG. 4: an example of changing branch in order to switch to an alternative itinerary;

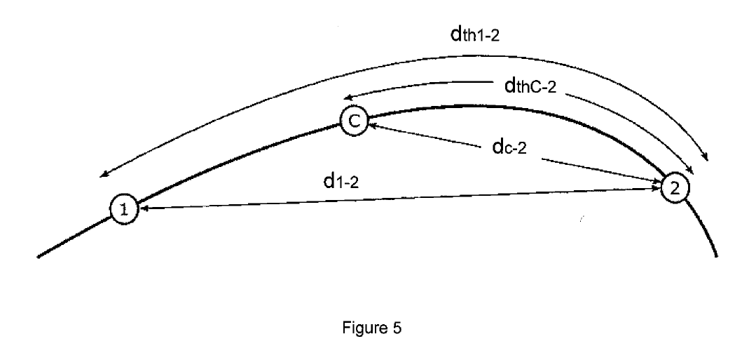

FIG. 5: distance before the next manoeuvre;

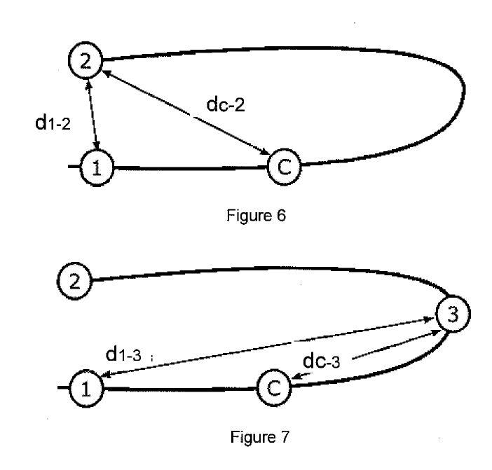

FIG. 6: a contrary example of an approximation of the distance before the next manoeuvre;

FIG. 7: an example of a method of improving the approximation of the distance before the next manoeuvre;

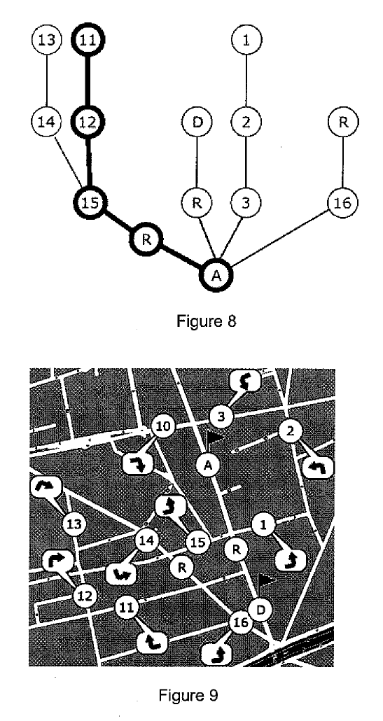

FIGS. 8 and 9: an example of a partial navigation tree in FIG. 8 and a representation of the points on a map in FIG. 9.

In the present application, “navigation system” means a device helping a user to travel from one place to another by determining an optimal itinerary and by supplying sound and/or visual indications making it possible to follow this itinerary, and advantageously geo-location means such as a GPS receiver, to situate the position of the station along this itinerary and allow the detection of the conditions of departure from the basic itinerary.

In the present application, “server” or “central server” or “central system” mean a hardware and software computer infrastructure that can be accessed remotely by means of a computer or public or private telecommunication network.

In the present application, “terminal” or “mobile station” means a device adapted for attachment in a vehicle and if necessary easily removable for use in roaming mode comprising hardware and software elements making it possible to communicate as required with a remote server, to interchange geographic data such as departure and arrival points, main and fallback itineraries, and furthermore making it possible to transmit the information relating to the itineraries to a user by viewing and/or voice synthesis means, and if necessary means making it possible to determine an itinerary portion in a geographic space of limited size.

In the present application, “user” means any person using one or more of the infrastructures defined above for the purpose of using the method according to the invention.

In the present application, “basic itinerary” means an itinerary adopted as best fulfilling the criteria supplied (the fastest, the shortest, the scenic, etc.).

The operating principle of the method according to the invention will be described with reference mainly to FIGS. 1 to 4.

For the server to establish an itinerary, a mobile station sends it a departure point and an arrival point. They may for example take the form of a postal address or geographic coordinates. This information may have been supplied by the user or obtained automatically, for example by triangulation with systems making it possible to make geo-locations, such as the GPS, Galileo, cellular network relays, etc. Otherwise, they may also be departure and/or arrival points originating from a third-party source, such as a logistics or delivery system or service, a postal service, a security service, etc., which transmit these points to the central server.

The server determines at least one optimal itinerary between these two points. To do this, it advantageously uses an itinerary-determination algorithm of a known type such as Dijkstra or A*. It also adopts a series of fallback points, or guide points, or itinerary-departure points, for cases when the user (voluntarily or otherwise) departs from the basic itinerary. The method for determining and using these points will be described below.

It must also generate the data needed to guide the user of the station, both for the basic itinerary and for the fallback points. To do this, the computer preferably lists all the paths leading to the arrival point. From those, it advantageously reserves only the ones that are close to the optimal itinerary.

For example, as illustrated in FIG. 1, the user wishes to go from the point D to the point A. The optimal itinerary follows the Jean Jaurès Boulevard in Boulogne-Billancourt. The central server computer adds thereto additional points with instructions allowing the user to continue his route if ever he departs, whether it be accidentally or intentionally, from the basic itinerary.

### Structure of the Guidance Data

The guidance data are represented by a set of points close to which the mobile station must initiate an action. The latter may be a guidance message to the user or a connection to the server in order to obtain additional guidance data.

These points are organized in a tree structure, as shown in FIGS. 2 to 4. The root of the tree is the destination or arrival point A of the itinerary. The leaves represent the beginning of a sequence of points guiding to the destination. By passing through the tree from a leaf to the root, the user chronologically follows an itinerary leading to the destination chosen by the user.

One of the leaves corresponds to the departure position chosen by the user. The other leaves are points through which the user passes if he departs from the optimal itinerary. FIG. 2 represents the tree of guidance messages corresponding to the case shown in FIG. 1.

If the user obeys the guidance instructions, he will progress along the branch of the tree to the root (FIG. 3).

If he does not follow the instructions, he will pass through guide points situated on the leaves of the tree. Guidance will then resume on the branch of the tree corresponding to that leaf. In our example, if the user turns at the first street to the left on the rue Carnot, he will go to point 11 and will change branch as shown in FIG. 4.

The management system of the station stores the last guide point through which he has passed (for example 12). If he passes close to a new point:
either this point is downstream of the last guide point in the direction of travel through the tree (for example 15), then it initiates the voice instruction and the cycle recommences;
or it is another leaf of the tree (for example 13 or 16), then it initiates the corresponding voice instruction and resumes the tree journey from this other leaf;
or it is neither of these two cases and the point is ignored because it corresponds to another itinerary crossing or running alongside that followed by the user.

A guide point may initiate:
an update of the distance before the next manoeuvre and/or;
an update of the time and distance before arrival and/or;
a voice message describing the manoeuvre to undertake (for example “turn right”) and/or;
a visual message describing the manoeuvre to undertake (for example a pictogram).

The guide points are preferably positioned upstream of the crossroads, at an optimal distance computed according to parameters such as the theoretical speed on the road taken, the complexity of the manoeuvre and the duration of the possible voice message. In addition to the main announcement at the time of the manoeuvre, a pre-announcement (for example “in 200 m, turn right”) may take place upstream at a distance determined according to similar criteria.

Between two guide points, the distance before the next manoeuvre will be computed according to the following formula (see FIG. 5):

dth C-2=dth 1-2*dC-2/d1-2

where:
the terminal C goes from point 1 to point 2;
dth 1-2 is the theoretical distance via the road before the next manoeuvre indicated in the last guide point encountered, supplied by the server in the guidance tree;
d1-2 is the distance as the crow flies between the last guide point encountered and the next manoeuvre, computed by the client;
dC-2 is the distance as the crow flies between the position of the user and the next manoeuvre, computed by the client.

This approximation operates all the better if the guide points are close to one another and the road followed is straight. On the other hand, if a road is very windy with long distances having no navigation point, the approximation may be imprecise. In the example of FIG. 6, the distance dC-2 increases whereas the distance via the road between the points C and 2 reduces.

To remedy this, the server will add to the tree the guide points that contain only an update of the distance before the next manoeuvre, of the distance before arrival and of the time before arrival (point 3 in FIG. 7).

### Tree Renewal Points

To limit the quantity of data that the terminal must process simultaneously, the guidance tree is sent in pieces corresponding to the geographic zone in which the client is located at any given time. The transmitted trees may therefore be partial, that is to say not having all their branches connected together. Nodes of the tree make it possible to initiate the loading of a new partial navigation tree corresponding to the zone to which the user is travelling. An overlap between the zones makes it easier to replace a partial tree with its successor.

FIG. 8 represents a navigation tree. The points marked R correspond to the loading of a new partial tree because the user is approaching the limit of the zone covered by the tree. FIG. 9 illustrates these points R on the site in question.

The tree-reloading points are positioned such that the terminal has the time to load the new tree before leaving the zone covered by the tree. So a distinction will be made between:

The zone of autonomy, in which the terminal is able to guide the user thanks to the tree that it has in memory, without risk of being short of data;

The coverage limit zone, in which it is time for the terminal to request a new tree from the server. The width of the coverage limit zone must be greater than the distance travelled by the user, determined by the average speed on each of the roads, for the time necessary for loading the map, determined by the bit rate of the network connecting the terminal to the server.

### Renewal Points of the Course of the Itinerary

If the terminal is capable of displaying a map, the itinerary is shown thereon. It is sent in the form of images with dimensions several times greater than that of the screen.

An overlap zone of a size slightly greater than that of the screen makes it easier to replace one course with its successor.

The course of the itinerary must also be renewed if the user has departed from the optimal itinerary.

The change-of-course points comprise parameters necessary for creating a portion of the course. The total of the information carried by these points between the leaf and the root of the tree makes it possible to plot the whole of the itinerary. The client software is not able to interpret these parameters. It simply returns them to the server in order to obtain the course. They may be:
a description of the road network used (list of section identifiers, etc.);
a graphic description of the road followed (polyline, etc.);
a session identifier allowing the server to recognize the client and to take advantage of the data specific to this client kept on the server. The current position in the navigation tree must also be specified so that the server plots the correct itinerary.

### Structure of an Action

To respond to all the cases specified above, a guidance action must include:
the distance before the next change of direction;
the distance before arrival;
the travelling time before arrival;
the identifier of the next point in the tree journey;
optionally, the data to be restored to the server in order to reconstruct the course of the itinerary;
optionally, the data needed to construct a message for the user;
optionally, a tree renewal instruction;
optionally, an itinerary course renewal instruction.

### Voice Guidance

If the client is capable of restoring the voice instructions to the user, the messages may be downloaded from the server as and when they are needed. In this case, the points will be added to the tree upstream of the guide points so that the voice message is available at the time of making the announcement. The distance between the downloading point and the point announcing the instruction will be computed by the server according to the duration of the voice message and the average speed on the road.

If the storage capacity of the client is sufficient, the most routine voice messages may be permanently stored in it. Only the less frequently used messages will then be downloaded from the server.

### Mapping Background

All the mapping is not necessarily stored on the client. The server provides the client with raster mapping divided into rectangular zones. The client is able to request these zones as required, as the user moves.

1. A navigation method allowing a centralized server to supply guidance functions capable of being used by a plurality of mobile terminals, wherein a plurality of users is provided with:
a central server comprising memory means capable of containing digital geographic data;
a processor, capable of establishing at least one itinerary between a departure point D and an arrival point A;
means of communication with the plurality of mobile terminals;
plurality of mobile terminals comprising:
means of communication with the central server;
and wherein, following the receipt of a request, the central server determines at least one itinerary between a given departure point and a given arrival point, defines a guidance zone making it possible to progress at least partially from this departure point to the arrival point, determines, at least for this guidance zone, a plurality of guide points and, for each of these points, a guidance instruction, these guide points and the associated instructions being capable of allowing the user to move in the zone by receiving guidance instructions for the purpose of allowing the terminal to come gradually closer to the arrival point;
wherein said central server transmits the guide points to the mobile terminal;
wherein said mobile terminal receives the said guide points;
wherein said mobile terminal, with the aid of the guide points received from the server, guides the terminal by comparing the current position of the terminal with those of the guide points and, in the case of correspondence between this position and a guide point, it supplies a guidance instruction corresponding to the point in question;
the guide points being organized according to a tree structure, the root of the tree being the arrival point A of the itinerary and the leaves representing the beginning of a sequence of points guiding to this arrival point, so that, by passing through the tree from a leaf to the root, the user chronologically follows an itinerary leading to the arrival point.

2. The navigation method of claim 1, wherein one of the leaves corresponds to the departure position of the itinerary, the other leaves being points through which the user passes if he departs from the optimal itinerary.

3. The navigation method of claim 1, wherein each mobile terminal comprises a management system adapted for storing the last guide point through which the mobile terminal has passed and, if the mobile terminal passes close to a new point:
either this point is downstream of the last guide point in the direction of travel through the tree and then the mobile terminal initiates the voice instruction and the cycle recommences;
or it is another leaf of the tree and then the mobile terminal initiates the corresponding voice instruction and resumes the tree journey from this other leaf;
or it is neither of these two cases: the management system then runs a test in order to reveal a possible particular case and, in the absence of a particular case, the point is ignored because it corresponds to another itinerary crossing or running alongside that followed by the user.

4. The navigation method of claim 3, wherein a particular case is capable of being revealed if the mobile terminal is incapable of determining its position.

5. The navigation method of claim 3, wherein a particular case is capable of being revealed if several consecutive detections of points of another branch are observed.

6. The navigation method of claim 1, wherein the guidance data are represented by a set of points close to which the mobile terminal must initiate an action.

7. The navigation method of claim 1, wherein when the terminal detects a position corresponding substantially to a renewal point, it launches a request for renewal of the guidance zone to the server, which, depending on the position of this point, establishes a new guidance zone making it possible to link the latter point to the destination point of the itinerary.

8. The navigation method of claim 1, wherein a possible division of the guidance zone into partial or intermediate zones is carried out by the server according to the memory capacity of the terminal if the latter is insufficient to effectively manage all the data to be transmitted by the server.

9. The navigation method of claim 1, wherein the server detects the type of terminal and consults a database allowing it to obtain the corresponding technical characteristics.

10. (canceled)

11. (canceled)

12. A software product comprising programmed code elements for use when loaded into a computer system and executed by said computer system for the implementation of a navigation method allowing a centralized server to supply guidance functions capable of being used by a plurality of mobile terminals, in which a plurality of users is provided with:
a central server comprising memory means capable of containing digital geographic data;
a processor, capable of establishing at least one itinerary between a departure point D and an arrival point A;
means of communication with the plurality of mobile terminals;
a plurality of mobile terminals comprising:
means of communication with the central device;
and in which, following the receipt of a request, the central server determines at least one itinerary between a given departure point and a given arrival point, defines a guidance zone making it possible to progress at least partially from this departure point to the arrival point, determines, at least for this guidance zone, a plurality of guide points and, for each of these points, a guidance instruction, these guide points and the associated instructions being capable of allowing the user to move in the said zone by receiving guidance instructions for the purpose of allowing the terminal to come gradually closer to the arrival point;
said server transmits these guide points to the mobile terminal;
said terminal receives the said guide points;
said terminal, with the aid of the guide points received from the server, guides the terminal by comparing the current position of the terminal with those of the guide points and, in the case of correspondence between this position and a guide point, it supplies a guidance instruction corresponding to the point in question;
the guide points being organized according to a tree structure, the root of the tree being the arrival point A of the itinerary and the leaves representing the beginning of a sequence of points guiding to this arrival point, so that, by passing through the tree from a leaf to the root, the user chronologically follows an itinerary leading to the arrival point.
